(19) United States
(12) Patent Application Publication
(10) Pub. No.: US 2025/0372293 A1
(43) Pub. Date: Dec. 4, 2025

(54) FERRITE CORE COIL FOR WIRELESS UNDERGROUND SENSING SYSTEMS

(71) Applicant: GroGuru, Inc., San Diego, CA (US)

(72) Inventor: Jeffrey E. Campbell, Boise, ID (US)

(73) Assignee: GroGuru, Inc., San Diego, CA (US)

(21) Appl. No.: 19/082,150

(22) Filed: Mar. 17, 2025

Related U.S. Application Data
(60) Provisional application No. 63/565,654, filed on Mar. 15, 2024.

(51) Int. Cl. H01F 17/04; H01F 1/34; H01F 5/06

(52) U.S. Cl. CPC H01F 17/045; H01F 1/344; H01F 5/06

(57) ABSTRACT

The present disclosure describes a ferrite core coil configured for use in a wireless underground sensing system that provides enhanced coil performance and functionality. The ferrite core coil may be a component of a wireless underground sensing probe transmitter, receiver, or bi-directional transceiver. The ferrite core coil may alternately be a component of an above-ground transmitter, receiver, or bi-directional transceiver that is used in conjunction with a wireless underground sensing system. The disclosed ferrite core coil may be used as a component of either or both of an underground and above-ground transmitter, receiver, or bi-directional transceiver of a wireless underground sensing system. The ferrite core coil includes a ferrite rod core with high relative magnetic permeability, a winding wrapped around a center portion of the ferrite rod core, a heat shrink covering applied around the windings and the ferrite rod, and two leads attached to the winding.

### CROSS-REFERENCE TO RELATED APPLICATIONS

This application claims the benefit of U.S. Provisional Patent Application Ser. No. 63/565,654, filed on Mar. 15, 2024, the disclosure of which is hereby incorporated in its entirety herein by reference.

### BACKGROUND

### Field of the Invention

The present disclosure relates to wireless communication systems, more particularly to ferrite core coils used in wireless underground sensor systems.

### Description of the Related Art

Sensing environmental conditions within an electromagnetic-absorbing material (e.g., soil, concrete, or water) is desired in a variety of applications, including agriculture. While various types of sensors are available for measuring environmental conditions within a material, communicating data from the sensors to outside the material can be challenging. Using a wired connection can be successful, but wires are undesirable or impractical in many applications. For example, in agricultural applications, wires are easily broken or damaged by rodent activity or tilling or harvesting operations. In other applications, use of wired connections is undesirable due to the potential for vandalism, unsightly appearance, or for other reasons. In addition, conventional methods of soil moisture measurement and data collection often require extensive manual labor, are prone to inaccuracies, and can be costly and time-consuming.

As a result, wireless underground sensing (WUGS) technology has become increasingly important in various fields, including agriculture, environmental monitoring, and infrastructure management. However, early WUGS technologies faced numerous challenges that prevented practical commercial application. These challenges included inadequate communications range due to the attenuation of propagating electromagnetic waves (particularly in an electromagnetic-absorbing material), unreliable operation due to changes in electromagnetic characteristics of the material, large equipment/antenna sizes that are incompatible with easy installation and removal of buried sensors, and excessive power consumption incompatible with long-term or battery-powered operation.

A key component in commercially viable wireless underground sensing systems for remote and automated data collection is transmitting and receiving coils. These coils play a crucial role in generating and detecting electromagnetic signals for communication purposes.

Ferrite rods are used in some applications as components of receiving coils, but are not typically used in transmitting coils. It is atypical for very high magnetic fields, high temperature stability, or very high magnetic dipole moments to be required in transmitting coils. Transmitting coils are typically air core coils.

WUGS systems for obtaining environmental data from within an electromagnetic-absorbing material have previously been disclosed. See, e.g., U.S. Pat. Nos. 10,502,865 and 11,445,274.

While ferrite core coils are known for use in certain applications such as wildlife telemetry and human body applications (e.g., pacemakers), existing coil designs for WUGS applications typically use air core coils. Air core coils are low cost and generally have excellent thermal stability, high Q (quality factor), and a large transmitted magnetic field. While effective, air core coils have limitations in terms of size, efficiency, and performance. Achieving a high magnetic dipole moment in a small diameter coil is challenging due to physical constraints and material properties.

There remains an unmet need for compact coils with improved efficiency and performance characteristics.

### SUMMARY

A ferrite core coil configured for use in a wireless underground sensing system is disclosed herein. The ferrite core coil may be a component of a wireless underground sensing probe transmitter, receiver, or bi-directional transceiver. The ferrite core coil may alternately be a component of an above-ground transmitter, receiver, or bi-directional transceiver that is used in conjunction with a wireless underground sensing system. The disclosed ferrite core coil may be used as a component of either or both of an underground and above-ground transmitter, receiver, or bi-directional transceiver of a wireless underground sensing system. The ferrite core coil includes a ferrite rod core with high relative magnetic permeability, a winding wrapped around a center portion of the ferrite rod core, a heat shrink covering applied around the windings and the ferrite rod, and two leads attached to the winding.

The disclosed ferrite core coil enhances the performance and functionality of transmitting and receiving coils in wireless underground sensing devices.

By using a ferrite rod core with high relative magnetic permeability, it is possible to integrate transmitting and receiving coils, along with electronics and batteries, into a compact probe. This offers numerous benefits in terms of cost, size, durability, and ease of installation.

### BRIEF DESCRIPTION OF THE DRAWINGS

Features, aspects, and embodiments are described in conjunction with the attached drawings. It will be understood, however, that the drawings are for the purpose of illustration and description only and are not intended as a definition of the limits of the present disclosure.

FIG. 1 depicts a schematic of an exemplary ferrite core coil, consistent with one or more exemplary embodiments of the present disclosure.

FIGS. 2A-2B provide exemplary ferrite core coil specifications and measurements, consistent with one or more exemplary embodiments of the present disclosure.

FIG. 3 is an image of a plurality of exemplary ferrite core coils, consistent with one of more exemplary embodiments of the present disclosure.

### DETAILED DESCRIPTION

A detailed description of one or more embodiments is provided below along with accompanying figures. Numerous specific details are set forth in the following description in order to provide a thorough understanding of the invention. These details are merely exemplary and are not intended to limit the scope of the invention. It will be understood by those skilled in the art that the invention is not limited to the specific details described herein, but rather extends beyond the specifically disclosed embodiments to other alternative embodiments and/or uses of the invention and obvious modifications and equivalents thereof. Thus, the present disclosure is not intended to be limited to the embodiments shown herein but is to be accorded the widest scope consistent with the principles and novel features disclosed herein.

The term “about” when used herein as a modifier is intended to convey that the numbers and ranges disclosed herein may be flexible as understood by ordinary skilled artisans and that practice of the disclosed invention by ordinary skilled artisans using properties that are outside of a literal range may nonetheless achieve the desired result.

A ferrite core coil configured for use in a wireless underground sensing system is disclosed herein. The ferrite core coil may be a component of a wireless underground sensing probe transmitter, receiver, or bi-directional transceiver. The ferrite core coil may alternately be a component of an above-ground transmitter, receiver, or bi-directional transceiver that is used in conjunction with a wireless underground sensing system. The disclosed ferrite core coil may be used as a component of either or both of an underground and above-ground transmitter, receiver, or bi-directional transceiver of a wireless underground sensing system.

A ferrite core coil configured for use as a wireless underground sensing probe is disclosed herein. The ferrite core coil includes a ferrite rod core with high relative magnetic permeability, a winding wrapped around a center portion of the ferrite rod core, a heat shrink covering applied around the windings and the ferrite rod, and two leads attached to the winding. The disclosed ferrite core coil enhances the performance and functionality of transmitting and receiving coils in wireless underground sensing devices. By using a ferrite rod core with high relative magnetic permeability, it is possible to integrate transmitting and receiving coils, along with electronics and batteries, into a compact probe. This offers numerous benefits in terms of cost, size, durability, and ease of installation.

To achieve the desired performance improvements, various design parameters for the ferrite core coil must be properly balanced. The primary factors that must be considered are the material of which the ferrite rod is composed, particularly the magnetic properties of the material; the diameter and length of the ferrite rod; and the overall length, number of turns, length of each turn, and wire gauge of the winding that surrounds the ferrite rod core.

The disclosed ferrite core coil is particularly useful for wireless underground sensing systems used for soil moisture measurement. An exemplary ferrite core coil may be used as a transmitting or a receiving coil. Another exemplary ferrite core coil may be used bi-directionally as both a transmitting and receiving coil. Further, an exemplary ferrite core coil is preferably compact, enabling its integration into probes for wireless underground sensing systems.

In some preferred exemplary embodiments, the ferrite core coil has a size and diameter that allows the coil to fit into cases for a desired application; an inductance that is close to the inductance of an air core coil that it will replace, which may for example be about 750 μH, so that replacing the coil does not require otherwise redesigning the circuit; a high effective magnetic moment; highly temperature stable inductance and magnetic moment, to prevent a temperature drift in inductance or magnetic moment from compromising power efficiency by lowering the signal that is transmitted and received.

At least fifty different ferrite core coil designs were made and evaluated, using different ferrite rod materials, ferrite rod diameters and lengths, and numbers of wire turns in the winding that surrounds the ferrite rod, to optimize the ferrite core coil design for use in a WUGS application.

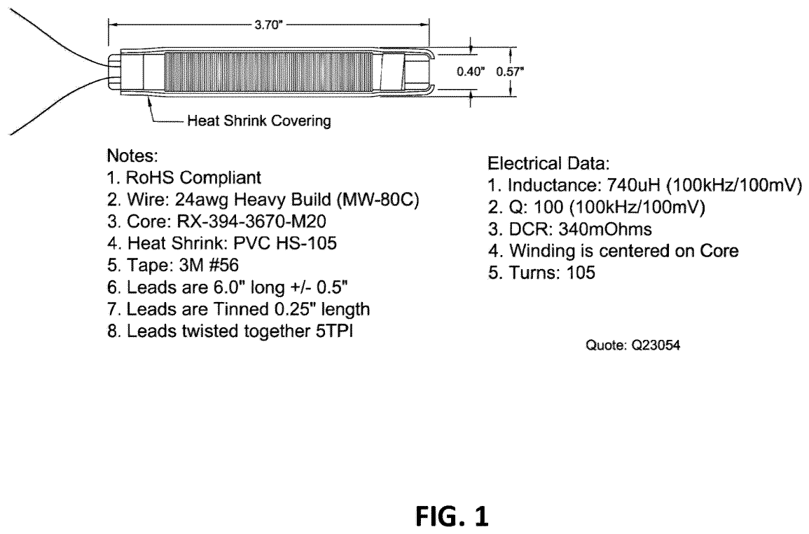

FIG. 1 depicts a schematic of a preferred exemplary ferrite core coil, consistent with one or more exemplary embodiments of the present disclosure. Characteristics of exemplary ferrite core coils are provided in FIG. 1. In exemplary embodiments, a ferrite core coil to be used for a wireless underground sensing probe may include a ferrite rod core with high relative magnetic permeability. In exemplary embodiments, high relative magnetic permeability may refer to a relative magnetic permeability of 3 to 100.

In exemplary embodiments, the ferrite rod may have a diameter of about 0.50 inches or less and a length of about 4 inches or less. In exemplary embodiments, the ferrite rod may have a diameter of about 0.40 inches and a length of about 3.7 inches. The ferrite core coil may further include a winding wrapped around a center portion of the ferrite rod with between about 10-300 turns. In some implementations, the winding preferably has about 50-150 turns, more preferably about 70-120 turns, even more preferably about 100-110 turns, and most preferably about 105 turns. The winding may, for example, be a 24 AWG gauge wire. In exemplary embodiments, the diameter of the winding may be about 0.511 mm.

In exemplary embodiments, the ferrite core coil may further include a heat shrink covering applied around the winding and the ferrite rod. In some exemplary embodiments, the heat shrink covering is composed of polyvinyl chloride to mechanically stabilize and protect the windings. In exemplary embodiments, the heat shrink covering may be composed of PVC HS-105. The heat shrink covering may be composed of other suitable materials, alone or in combination, as appropriate for the specific application. In other exemplary embodiments, other types of coverings such as shellac, lacquer, plastic dips, adhesive tapes, or other suitable coverings may be used to mechanically stabilize and protect the winding.

In exemplary embodiments, the ferrite core coil may further include two leads attached to the winding. The two leads may, for example, have a length of between about 5.5 to 6.5 inches, where the leads may be tinned for a length of between about 0.2 to 0.3 inches. In other exemplary embodiments, the two leads may have lengths that are suitable for the desired application. The length of the two leads does not impact the overall coil design, and thus various lengths may be used.

In exemplary embodiments, the diameter of the ferrite core coil may be about 0.57 inches, where the ferrite core may have a diameter of about 0.40 inches and the length of the ferrite core may be about 3.70 inches.

In exemplary embodiments, the ferrite core coil may be comparable in its functional performance to conventional air core (non-ferrite) coils that are about 4.0 inches in diameter. Accordingly, in exemplary embodiments, the ferrite core coil may allow achieving a high magnetic dipole moment in a compact size suitable for integration into a probe. The compact size may allow the possibility of placing the ferrite core coil in the interior of a probe along with desired electronics and batteries. For example, a commercial product having a 40 mm probe diameter may readily fit needed electronics, 3D cell batteries, and the disclosed ferrite core coil in its interior and may achieve all of the benefits described herein. By contrast, a 4 inch diameter coil is significantly too large to fit inside a 40 mm probe.

In exemplary embodiments, the ferrite core coil offers several performance advantages over traditional air core coil designs. These include higher efficiency, improved durability, and reduced size.

In exemplary embodiments, in the context of higher efficiency, the high relative magnetic permeability of the ferrite rod core may allow for a higher magnetic dipole moment to be achieved, resulting in improved signal strength and range.

In exemplary embodiments, in the context of improved durability, the integration of transmitting and receiving coils, along with electronics and batteries, into a single probe may improve the durability of a wireless underground sensing probe, reducing the likelihood of damage during installation and operation.

In exemplary embodiments, in the context of reduced size, in addition to allowing a ferrite core coil to be included within a probe, the overall size of the wireless underground sensing probe may be reduced.

In exemplary embodiments, the ferrite core coil depicted in FIG. 1 is compact and has performance that is similar to or exceeds the performance of conventional air core coils.

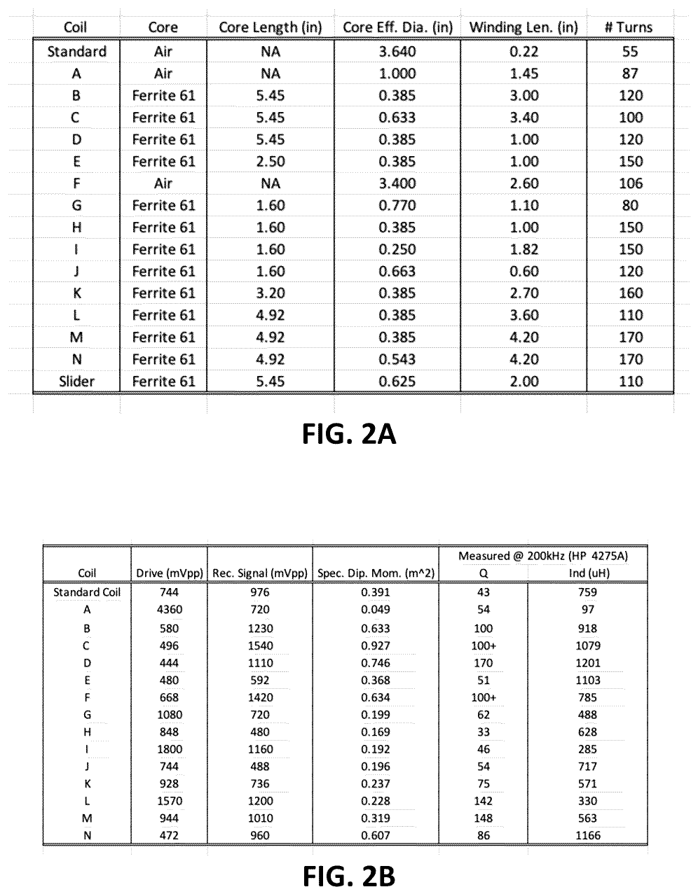

FIGS. 2A-2B show exemplary ferrite core coil specifications and measurements, consistent with one or more exemplary embodiments of the present disclosure. In exemplary embodiments, all of the ferrite core coils listed in FIGS. 2A-2B may be manufactured to be functionally similar to the ferrite core coil depicted in FIG. 1. FIG. 2A provides exemplary coil types around a type 61 ferrite rod with various design specifications. FIG. 2B provides measured coil properties of these coils. Accordingly, additional exemplary ferrite rods with listed perimeters consistent with principles of the disclosed exemplary embodiments as displayed in FIG. 1 may be manufactured.

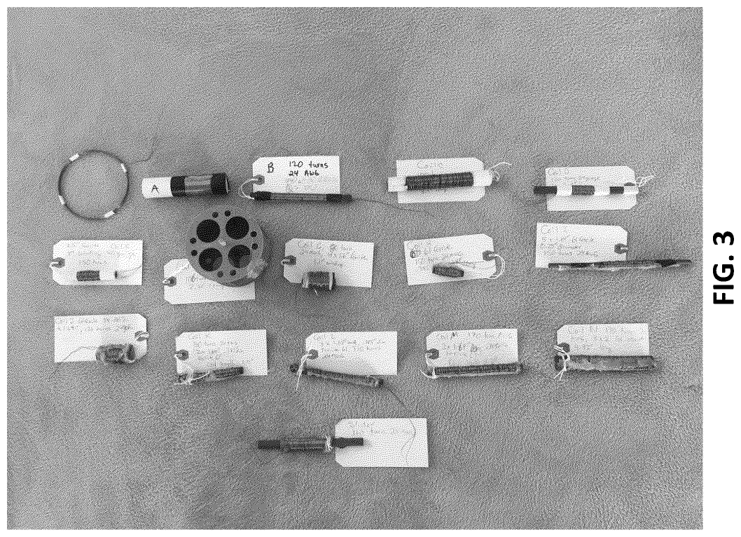

FIG. 3 is an image of a plurality of ferrite core coils, consistent with one of more exemplary embodiments of the present disclosure. In exemplary embodiments, all of the ferrite core coils listed in FIG. 3 may be manufactured to be functionally similar to the ferrite core coil depicted in FIG. 1.

As discussed above, ferrite core coils listed in FIG. 3 may be integrated within below ground transmitting devices. To provide further context, a conventional ground transmitting device may contain a section of PVC pipe having a 4 inch inner diameter and a length of approximately 9 inches. A pipe may contain a ferrite core coil, batteries, and requisite electronics and may be connected via cable to a soil moisture probe that may, for example, be approximately 32 or 40 mm in diameter. In exemplary embodiments, a soil moisture probe may have a length ranging from about 0.6 meters to about 1.6 meters, depending on the desired soil measuring depths.

The large diameter of the pipe is required to fit a conventional air core coil and requires extensive potting material to waterproof. The addition of a cable to the probe increases the likelihood of damage due to rodent chewing or typical agricultural activities such as tilling, spraying, harvesting, and the like. All of these requirements add expense, increase possible damage when deployed, and require more time to install.

Accordingly, the disclosed ferrite core coil may provide numerous benefits. For example, the ferrite core coil may have a compact size compared to conventional air core coils, while providing at least equivalent performance in terms of transmitting and receiving. As discussed above, the ferrite core coils may be integrated, along with electronics and batteries, into a single probe. This integration may offer several advantages, including reduced costs, simplified installation, and improved durability. Accordingly, in exemplary embodiments, a probe may be manufactured using existing manufacturing processes, with a ferrite core coil incorporated into an existing probe structure.

In exemplary embodiments, a probe structure with a coil incorporated therein allows for it to be more dependable and have less avenues for failure during field deployment. Further, it may allow for quicker installation, as a single hole may be drilled into the ground and a probe may be inserted. By contrast, conventional approaches require drilling a first hole, inserting the probe, and then creating a short trench for another hole, so that the probe is in one hole and a pipe section (as described above) is in the other hole.

In addition, ferrite core coils described herein may have applicable frequencies beyond 173.8 kHz. In exemplary embodiments, ferrite core coils may have a low intrinsic adjusted resistance allowing for improved coil Q (quality factor) and reduced wire diameter. Accordingly, due to a ferrite core coil having a high Q factor, it may allow for transmission of a strong signal while using low power and reject out-of-band noise, thereby improving reception range, when used in receiving circuits.

In exemplary embodiments, ferrite core coils may have a dependence of Q and inductance vs. temperature from −40° C. to 65° C. of less than 0.5%, which may be easily tolerated in field use. Further, in addition to mechanical ruggedness, the ferrite core coils may have precision, namely, lack of variance from unit to unit.

Other embodiments incorporating various modifications and alterations may be used in the design and manufacture of the apparatus consistent with exemplary embodiments of the present disclosure without departing from the spirit and scope of the accompanying claims.

Throughout this disclosure, unless the context requires otherwise, the word “comprise” and variations thereof such as “comprises” or “comprising” should be understood to imply the inclusion of a stated integer or step or group of integers or steps but not to the exclusion of any other integer or step or group of integers or steps.

### EXEMPLARY EMBODIMENTS

The following concise examples of various embodiments of the invention are now be provided, the examples disclosing combinations of features described previously above.

Example 1. A ferrite core coil to be utilized for a wireless underground sensing probe, including:
a ferrite rod core with high relative magnetic permeability,
a winding wrapped around a center portion of the ferrite rod core;
a heat shrink covering applied around the windings and the ferrite rod, the heat shrinking covering composed of a polyvinyl chloride; and
two leads attached to the winding.

Example 2. The ferrite core coil of Example 1, where the ferrite rod core has a relative magnetic permeability of 3 to 100.

Example 3. The ferrite core coil of Example 1, where the winding has about 10-300 turns.

Example 4. The ferrite core coil of Example 1, where the winding has about 50-150 turns.

Example 5. The ferrite core coil of Example 1, where the winding has about 70-120 turns.

Example 6. The ferrite core coil of Example 1, where the winding has about 100-110 turns.

Example 7. The ferrite core coil of Example 1, where the winding has about 105 turns.

Example 8. The ferrite core coil of Example 2, where the winding has about 70-120 turns.

Example 9. The ferrite core coil of Example 2, where the winding has about 100-110 turns.

Example 10. The ferrite core coil of Example 2, where the winding has about 105 turns.

Example 11. The ferrite core coil of Example 2, where the ferrite core has a diameter of about 0.5 inches or less and a length of about 4.0 inches or less.

Example 12. The ferrite core coil of Example 5, where the ferrite core has a diameter of about 0.5 inches or less and a length of about 4.0 inches or less.

Example 13. The ferrite core coil of Example 9, where the ferrite core has a diameter of about 0.5 inches or less and a length of about 4.0 inches or less.

Example 14. The ferrite core coil of Example 10, where the ferrite core has a diameter of about 0.5 inches or less and a length of about 4.0 inches or less.

Example 15. The ferrite core coil of Example 13, where the diameter of the ferrite core is about 0.40 inches and the length of the ferrite core is about 3.70 inches.

Example 16. The ferrite core coil of Example 15, where the diameter of the ferrite core coil is about 0.57 inches, where the diameter of the ferrite rod core is about 0.40 inches and the length of the ferrite rod core is about 3.70 inches.

Example 17. The ferrite core coil of Example 16, where the diameter of the winding is about 0.511 mm.

Example 18. The ferrite core coil of Example 16, where the two leads have a length between about 5.5 to 6.5 inches, where the leads are tinned for a length of between about 0.2 to 0.3 inches.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A ferrite core coil for use in a wireless underground sensing probe comprising:
a. a ferrite rod core with high relative magnetic permeability;
b. a winding wrapped around a center portion of the ferrite rod core;
c. a heat shrink covering applied around the windings and the ferrite rod, wherein the heat shrinking covering is composed of a polyvinyl chloride; and
d. two leads attached to the winding.

2. The ferrite core coil of claim 1, wherein the ferrite rod core has a relative magnetic permeability of 3 to 100.

3. The ferrite core coil of claim 1, wherein the winding has about 10-300 turns.

4. The ferrite core coil of claim 1, wherein the winding has about 50-150 turns.

5. The ferrite core coil of claim 1, wherein the winding has about 70-120 turns.

6. The ferrite core coil of claim 1, wherein the winding has about 100-110 turns.

7. The ferrite core coil of claim 1, wherein the winding has about 105 turns.

8. The ferrite core coil of claim 2, wherein the winding has about 70-120 turns.

9. The ferrite core coil of claim 2, wherein the winding has about 100-110 turns.

10. The ferrite core coil of claim 2, wherein the winding has about 105 turns.

11. The ferrite core coil of claim 2, wherein the ferrite core has a diameter of about 0.5 inches or less and a length of about 4.0 inches or less.

12. The ferrite core coil of claim 5, wherein the ferrite core has a diameter of about 0.5 inches or less and a length of about 4.0 inches or less.

13. The ferrite core coil of claim 9, wherein the ferrite core has a diameter of about 0.5 inches or less and a length of about 4.0 inches or less.

14. The ferrite core coil of claim 10, wherein the ferrite core has a diameter of about 0.5 inches or less and a length of about 4.0 inches or less.

15. The ferrite core coil of claim 13, wherein the diameter of the ferrite core is about 0.40 inches and the length of the ferrite core is about 3.70 inches.

16. The ferrite core coil of claim 15, wherein the diameter of the ferrite core coil is about 0.57 inches, wherein the diameter of the ferrite rod core is about 0.40 inches and the length of the ferrite rod core is about 3.70 inches.

17. The ferrite core coil of claim 16, wherein the diameter of the winding is about 0.511 mm.

18. The ferrite core coil of claim 16, wherein the two leads have a length between about 5.5 to 6.5 inches, wherein the leads are tinned for a length of between about 0.2 to 0.3 inches.
